(19) United States
(12) Patent Application Publication
(10) Pub. No.: US 2023/0257598 A1
(43) Pub. Date: Aug. 17, 2023

(54) AQUEOUS COATING DISPERSION

(71) Applicant: PPG INDUSTRIES OHIO, INC., CLEVELAND, OH (US)

(72) Inventors: MARK PAUL BOWMAN, NEW KENSINGTON, PA (US); VENICE POMTILA AKELO MAGUNGA, NEWARK, DE (US); LUCAS MANUEL DOS SANTOS FREIRE, PITTSBURGH, PA (US)

(21) Appl. No.: 18/055,062

(22) Filed: Nov. 14, 2022

Related U.S. Application Data
(60) Provisional application No. 63/302,282, filed on Jan. 24, 2022.

(51) Int. Cl. C09D 7/48; C08C 19/14; C09D 7/65; C09D 7/61

(52) U.S. Cl. CPC C09D 7/48; C08C 19/14; C09D 7/61; C09D 7/65

(57) ABSTRACT

A rubber coating layer is prepared from a sprayable aqueous coating dispersion including: a rubber dispersion including a rubber binder dispersed in an aqueous medium, a sulfur-containing vulcanization agent, and a platy inorganic material. The coating dispersion or a film formed from the coating dispersion is vulcanized at a temperature of from 100° C. to less than 160° C. for up to 1 hour to form the rubber coating layer having a melt temperature of greater than 60° C. A sprayable pre-vulcanized coating dispersion is prepared from a coating dispersion including: a rubber dispersion comprising a rubber binder dispersed in an aqueous medium, a sulfur-containing vulcanization agent, and a platy inorganic material. The coating dispersion is vulcanized at a temperature of from 70° C. to less than the boiling point of the aqueous medium to form the pre-vulcanized coating dispersion.

### STATEMENT REGARDING FEDERALLY SPONSORED RESEARCH

This invention was made with Government support under Contract No. HQ0034-15-2-0007 to National Center for Manufacturing Sciences (NCMS) and NCMS-PPG Subcontract No. 201899-140971. The United States Government may have certain rights in this invention.

### FIELD OF THE INVENTION

The present invention relates to an aqueous coating dispersion and a rubber coating layer formed therefrom.

### BACKGROUND OF THE INVENTION

Degradation caused by oxidative aging and/or ultraviolet or ozone degradation can cause rubber components to fail. For example, rubber vehicle tires experiencing oxidative aging and/or ultraviolet or ozone degradation may fail in the form of a flat tire or blowout, and such failure can cause vehicular accidents resulting in fatal or non-fatal injuries and damage to the vehicle itself. Rubber components stored for long periods of time prior to use (e.g., spare tires) are particularly susceptible to failure due to oxidative aging and/or ultraviolet or ozone degradation.

### SUMMARY OF THE INVENTION

The present invention is directed to a rubber coating layer prepared from a sprayable aqueous coating dispersion including: a rubber dispersion including a rubber binder dispersed in an aqueous medium, a sulfur-containing vulcanization agent, and a platy inorganic material. The coating dispersion or a film formed from the coating dispersion is vulcanized at a temperature of from 100° C. to less than 160° C. for up to 1 hour to form the rubber coating layer having a melt temperature of greater than 60° C.

The present invention is also directed to a coated rubber article, including: a rubber article to which a sprayable aqueous coating dispersion has been applied and subsequently vulcanized to form a rubber coating layer. The coating dispersion includes: a rubber dispersion including a rubber binder dispersed in an aqueous medium, a sulfur-containing vulcanization agent, and a platy inorganic material. The coating dispersion is vulcanized at a temperature of from 100° C. to less than 160° C. for up to 1 hour to form the rubber coating layer having a melt temperature of greater than 60° C.

The present invention is also directed to a method of forming a coated rubber article, including: applying a sprayable aqueous coating dispersion to a rubber article and vulcanizing the applied coating dispersion at a temperature of from 100° C. to less than 160° C. for up to 1 hour to form a rubber coating layer having a melt temperature of greater than 60° C. over the rubber article. The coating dispersion includes: a rubber dispersion including a rubber binder dispersed in an aqueous medium, a sulfur-containing vulcanization agent, and a platy inorganic material.

The present invention is also directed to a sprayable pre-vulcanized coating dispersion prepared from a coating dispersion including: a rubber dispersion including a rubber binder dispersed in an aqueous medium, a sulfur-containing vulcanization agent, and a platy inorganic material. The coating dispersion is pre-vulcanized at a temperature of from 70° C. to less than the boiling point of the aqueous medium to form the pre-vulcanized coating dispersion.

The present invention is also directed to a rubber coating layer formed from a sprayable pre-vulcanized coating dispersion prepared from a coating dispersion including: a rubber dispersion including a rubber binder dispersed in an aqueous medium, a sulfur-containing vulcanization agent, and a platy inorganic material. The coating dispersion is pre-vulcanized at a temperature of from 70° C. to less than the boiling point of the aqueous medium to form the pre-vulcanized coating dispersion. The rubber coating layer is formed by applying the pre-vulcanized coating dispersion over a surface of an article.

The present invention is also directed to a coated rubber article, including: a rubber article to which a sprayable pre-vulcanized coating dispersion has been applied to form a rubber coating layer. The pre-vulcanized coating dispersion is prepared from a coating dispersion including: a rubber dispersion including a rubber binder dispersed in an aqueous medium, a sulfur-containing vulcanization agent, and a platy inorganic material. The coating dispersion is pre-vulcanized at a temperature of from 70° C. to less than the boiling point of the aqueous medium to form the pre-vulcanized coating dispersion.

The present invention is also directed to a method of forming a coated rubber article, including: pre-vulcanizing a coating dispersion to form a sprayable pre-vulcanized coating dispersion and applying the pre-vulcanized coating dispersion to a rubber article to form a rubber coating layer over the rubber article. The coating dispersion includes: a rubber dispersion including a rubber binder dispersed in an aqueous medium, a sulfur-containing vulcanization agent, and a platy inorganic material. The coating dispersion is pre-vulcanized at a temperature of from 70° C. to less than the boiling point of the aqueous medium to form the pre-vulcanized coating dispersion.

### DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and the plural encompasses the singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” binder, “a” rubber, and the like refer to one or more of any of these items.

As used herein, a “film-forming resin” refers to a self-supporting continuous film on at least a horizontal surface of a substrate upon removal of any diluents or carriers present in the composition or upon curing. Also, as used herein, the term “polymer” is meant to refer to prepolymers, oligomers, and both homopolymers and copolymers. The term “resin” is used interchangeably with “polymer”.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the invention.

The present invention is directed to a rubber coating layer prepared from a sprayable aqueous coating dispersion comprising: a rubber dispersion comprising a rubber binder dispersed in an aqueous medium, a sulfur-containing vulcanization agent, and a platy inorganic material.

As used herein, the term “dispersion” refers to a two-phase system in which one phase includes finely divided particles distributed throughout a second liquid phase, which is a continuous phase. The continuous phase may comprise the aqueous medium, in which polymeric particles (e.g., the rubber binder) are suspended therein.

The coating dispersion comprises a rubber dispersion. The rubber dispersion may comprise a rubber binder dispersed in an aqueous medium. The rubber dispersion may also comprise a surfactant suitable to keep the rubber binder dispersed in the aqueous medium so as to form a dispersion (as opposed to the rubber binder settling to the bottom of the aqueous medium). It will be appreciated that the “rubber dispersion” refers to the dispersion comprising the rubber binder, aqueous medium, and optional surfactant, while the “coating dispersion” refers to the dispersion comprising the rubber dispersion, sulfur-containing vulcanization agent, platy inorganic material, and any other components.

The rubber dispersion comprises an aqueous medium. As used herein, an “aqueous medium” refers to a carrier-fluid of the rubber dispersion that comprises at least 90 weight percent water, based on the total weight of the carrier-fluid. The carrier-fluid can comprise at least 95 weight percent water, such as 100 weight percent water, based on the total weight of the carrier-fluid. The carrier-fluid can also comprise less than 10 weight percent organic solvent, such as less than 5 weight percent, or 0 weight percent, based on the total weight of the carrier-fluid. The rubber dispersion may be substantially free of organic solvents, comprising less than 5 weight percent organic solvent, based on total weight of the carrier-fluid. The rubber dispersion may be essentially free of organic solvents, comprising less than 1 weight percent organic solvent, based on total weight of the carrier-fluid. The rubber dispersion may be completely free of organic solvents, comprising 0 weight percent organic solvent, based on total weight of the carrier-fluid. Non-limiting examples of organic solvents that can be used include glycols, glycol ether alcohols, alcohols, ketones, glycol diethers, and diesters. Other non-limiting examples of organic solvents include aromatic and aliphatic hydrocarbons. The coating dispersion may also comprise an aqueous medium.

The rubber binder may comprise a butyl rubber binder. The butyl rubber binder may be dispersed in the aqueous medium. The butyl rubber binder may comprise a butyl-containing polymer. Non-limiting examples of butyl-containing polymers may include butyl rubber, such as isobutylene-isoprene copolymer (IIR); bromobutyl rubber, e.g., bromoisobutylene-isoprene copolymer (BIIR); chlorobutyl rubber, e.g., chloroisobutylene-isoprene copolymer (CIIR); and isobutylene rubber. Butyl rubber may comprise a poly(isobutylene) homopolymer or a copolymer of poly(isobutylene) with isoprene. Modified butyl rubbers include halogenated poly(isobutylene) and its copolymers and isoprene. Polymers or copolymers that contain more than 50% isobutylene, such as poly(isobutylene-co-acrylonitrile), may be used. A non-limiting example of a butyl rubber binder is AQUALAST BL-100 butyl latex dispersion available from Lord Corporation (Cary, NC).

The rubber binder may additionally or alternatively comprise a non-butyl rubber binder, and a non-limiting example of non-butyl rubber binder includes a polyisoprene latex dispersion, a non-limiting example of which is a polyisoprene latex dispersion bearing the trade name CARIFLEX available from Kraton Corporation (Houston, TX).

Suitable rubber binders include those rubbers generally used for forming tires, such as: diene-based rubbers such as various types of natural rubber (NR), various types of polyisoprene rubber (IR), various types of polybutadiene rubber (BR), various types of styrenebutadiene copolymer rubber (SBR), acrylonitrile-butadiene copolymer rubber, chloroprene rubber (CR), and their partial hydrogenates or (halogenated) butyl rubber (IIR), ethylene-propylene diene copolymer rubber (EPDM), acryl rubber (ACM), and the like. These may be used alone or in any mixtures thereof.

The rubber binder may be capable of forming a dispersion in the aqueous medium. A surfactant may be used to render the rubber binder capable of forming dispersion. For example, the rubber binder may comprise a rubber latex dispersion. Suitable commercially available rubber latex dispersions for use in the aqueous coating dispersions of the present invention include AQUALAST BL-100 or a CARIFLEX product. The latex dispersion may comprise an ionic surfactant package which stabilizes the latex dispersion.

The coating dispersion may comprise from 50 to 99 weight percent of the rubber binder, based on total solids of the coating dispersion, such as from 50 to 97 weight percent, from 55 to 80 weight percent, or from 60 to 75 weight percent. The coating dispersion may comprise at least 50 weight percent of the rubber binder, based on total solids of the coating dispersion, such as at least 55 weight percent, or at least 60 weight percent. The coating dispersion may comprise up to 97 weight percent of the rubber binder, based on total solids of the coating dispersion, such as up to 80 weight percent, or up to 75 weight percent.

The coating dispersion comprises a sulfur-containing vulcanization agent. A vulcanization agent is a compound capable of introducing chemical crosslinks into the rubber matrix to form a three-dimensional network. Non-limiting examples of suitable sulfur-containing vulcanization agents include elemental sulfur or sulfur donating vulcanizing agents, such as an amine disulfide, polymeric disulfide, or sulfur olefin adducts. The sulfur-containing vulcanization agent may be water dispersible. The sulfur-containing vulcanization agent may be included in a vulcanization package added to the coating dispersion which package further comprises a promoter and/or an accelerant that increases the speed at which the coating dispersion is vulcanized.

The coating dispersion may comprise from 1 to 10 weight percent of the vulcanization package, based on total solids of the coating dispersion, such as from 2 to 8 weight percent, or from 3 to 6 weight percent. The coating dispersion may comprise at least 1 weight percent of the vulcanization package, based on total solids of the coating dispersion, such as at least 2 weight percent, or at least 3 weight percent. The coating dispersion may comprise up to 10 weight percent of the vulcanization package, based on total solids of the coating dispersion, such as up to 8 weight percent, or up to 6 weight percent.

The coating dispersion comprises a platy material. They platy material may comprise an inorganic material. As used herein, an “inorganic material” refers to materials and substances that are not organic, i.e., do not include carbon-based materials. The term “platy” refers to a structure in which one dimension is substantially smaller than the two other dimensions of the structure resulting in a flat type appearance. The platy inorganic material may be in the form of stacked lamellae, sheets, platelets, or plates with a relatively pronounced anisometry. The platy inorganic material, can further improve the barrier performance of the resulting coating by reducing the permeability of liquids and gases.

The coating dispersion may comprise from 1 to 40 weight percent of the platy material, based on total solids of the coating dispersion, such as from 4 to 25 weight percent, or from 10 to 20 weight percent. The coating dispersion may comprise at least 1 weight percent of the platy material, based on total solids of the coating dispersion, such as at least 4 weight percent, or at least 10 weight percent. The coating dispersion may comprise up to 40 weight percent of the platy material, based on total solids of the coating dispersion, such as up to 25 weight percent, or up to 20 weight percent.

Suitable platy inorganic materials can include those having a high aspect ratio, for example. Suitable high aspect ratio platy inorganic materials include, for example, vermiculite, mica, talc, wollastonite, chlorite, metal flakes, and platy silicas. The platy inorganic material may comprise a platy clay, such as vermiculite. The platy inorganic material may have an average diameter of from 1 to 20 microns, from 2 to 5 microns, or from 2 to 10 microns, as determined using the size distribution curve generated using a Malvern Mastersizer 2000 instrument according to the manufacturer’s instructions. The aspect ratio of the platy inorganic material can be at least 10:1, such as at least 20:1 or at least 100:1. For example, mica flakes may have an aspect ratio of at least 20:1, talc may have an aspect ratio of from 10:1 to 20:1, and vermiculite may have an aspect ratio of from 10:1 to 15,000:1, such as 200:1 to 10,000:1 or 10,000:1 to 15,000:1. Aspect ratio is determined using a high resolution transmission electron microscopy (TEM).

The coating dispersion may optionally comprise a black pigment, such as a carbon black pigment. When included, the coating dispersion may comprise from greater than 0 to 5 weight percent of the black pigment, based on total solids of the coating dispersion, such as from 1 to 3 weight percent, or from 1 to 2 weight percent. The coating dispersion may comprise greater than 0 weight percent of the black pigment, based on total solids of the coating dispersion, such as at least 1 weight percent. The coating dispersion may comprise up to 5 weight percent of the black pigment, based on total solids of the coating dispersion, such as up to 3 weight percent, or up to 2 weight percent.

The coating dispersion may optionally comprise other additives, non-limiting examples of which include plasticizers, abrasion resistant particles, corrosion resistant particles, corrosion inhibiting additives, anti-oxidants, other pigments, hindered amine light stabilizers, UV light absorbers and stabilizers, flow and surface control agents (e.g., a wetting agent), thixotropic agents, reactive diluents, catalysts, reaction inhibitors, defoamers, and other customary auxiliaries.

When included, the other additives (anything beyond the rubber dispersion, sulfur-containing vulcanization package, platy material, and black pigment) may be included in the coating dispersion in an amount of from greater than 0 to 11 weight percent, based on total solids of the coating dispersion, such as from 3 to 10 weight percent, or from 8 to 9 weight percent. The coating dispersion may comprise greater than 0 weight percent of the other additives, based on total solids of the coating dispersion, such as at least 3 weight percent, or at least 8 weight percent. The coating dispersion may comprise up to 11 weight percent of the other additives, based on total solids of the coating dispersion, such as up to 10 weight percent, or up to 9 weight percent.

The coating dispersion may be pre-vulcanized. As used herein, “pre-vulcanized” refers to the coating dispersion (the aqueous dispersion) undergoing a vulcanization process prior to application of the coating dispersion to a substrate, thus forming a pre-vulcanized coating dispersion. For example, the coating dispersion may be contained in a container and vulcanized in the container prior to removal from the container for application thereof onto a surface of an article (also referred to herein interchangeably as a “substrate”). As used herein, “vulcanized” refers to the solid coating layer formed over the substrate and from the coating dispersion undergoing a vulcanization process.

To form the pre-vulcanized coating dispersion, the coating dispersion may be pre-vulcanized by application of a temperature of from 70° C. to less than the boiling point of the aqueous medium to form the pre-vulcanized coating dispersion. For example, to pre-vulcanize the coating dispersion, the coating dispersion may be pre-vulcanized at a temperature of from 70° C. to less than 100° C. (the boiling point of water in the aqueous medium at standard pressure conditions (e.g., atmospheric pressure)). The aqueous medium may be subjected to temperatures exceeding 100° C. at higher pressure conditions (relative to standard pressure), because the boiling point of water exceeds 100° C., and the temperature to which the aqueous medium may be subjected at higher pressures coincides with a temperature below the boiling point of the water from the aqueous medium at the particular higher pressure. The pre-vulcanized coating dispersion may be sprayable.

Alternatively, the coating dispersion may not be pre-vulcanized prior to application of the coating dispersion onto the substrate.

The coating dispersion and/or the pre-vulcanized coating dispersion (hereinafter referred to interchangeably as the “coating dispersion” unless specifically indicated otherwise) may be applied to a substrate (e.g., a surface thereof). In some examples, the substrate may not be subjected to an abrasive scrubbing process prior to application of the coating dispersion. The coating dispersion can be applied by electrocoating, spraying, electrostatic spraying, dipping, rolling, brushing, and the like. The coating dispersion may be spray applied to the substrate, such that the coating dispersion is a sprayable aqueous coating dispersion. Thus, the viscosity of the coating dispersion may be sufficiently low so as to be applied by a spray applicator, such as having a viscosity of from 1 to 3,000 centipoise (cps), as determined according to ASTM D5324-16. Viscosity refers to Brookfield viscosity measured at 25° C. using a Brookfield Viscometer DV-II+Pro using spindle #2 at 60 RPM. The coating dispersion having a viscosity within this range may be considered a flowable composition.

The coating dispersion may be applied to a dry film thickness of from 1 to 50 mils (25 to 1270 microns). The applied coating dispersion may be dried and/or vulcanized to form a rubber coating layer over the substrate.

In the case of the coating dispersion being the pre-vulcanized coating dispersion, the applied coating dispersion may be dried to form the rubber coating layer at ambient temperature (e.g., 20° C.-25° C.) for from 1 hour to 7 days and without applying elevated temperatures to the applied coating dispersion. “Dried” refers to the coating layer no longer being flowable (unlike the coating dispersion itself).

In the case of the coating dispersion not being pre-vulcanized, the coating dispersion applied to the substrate or a film formed from the coating dispersion (e.g., by at least partial drying at ambient temperatures) is vulcanized at a temperature of from 100° C. to less than 160° C., such as from 100° C. to 150° C., from 100° C. to 120° C., or from 100° C. to 116° C., for up to 1 hour to form the rubber coating layer.

The rubber coating layer formed over the substrate may have a melt temperature of greater than 60° C., such as at least 100° C., at least 130° C., at least 150° C., or at least 180° C., as determined according to the Dynamic Mechanical Analysis (DMA) test defined in Example 3.

The substrate over which the rubber coating layer is formed may comprise a rubber article. The rubber article may be vulcanized before application of the coating dispersion thereto, or the rubber article may not be vulcanized before application of the coating dispersion thereto.

The rubber article may comprise a vehicle component. The term “vehicle” is used in its broadest sense and includes all types of aircraft, spacecraft, watercraft, and ground vehicles. For example, the vehicle can include, but is not limited to an aerospace vehicle (a component of an aerospace vehicle, such as an aircraft such as, for example, airplanes (e.g., private airplanes, and small, medium, or large commercial passenger, freight, and military airplanes), helicopters (e.g., private, commercial, and military helicopters), aerospace vehicles (e.g., rockets and other spacecraft), and the like). The vehicle can also include a ground vehicle such as, for example, animal trailers (e.g., horse trailers), all-terrain vehicles (ATVs), cars, trucks, buses, vans, heavy duty equipment, agricultural vehicles (e.g., tractors), golf carts, motorcycles, bicycles, snowmobiles, trains, railroad cars, and the like. The vehicle can also include watercraft such as, for example, ships, boats, hovercrafts, and the like. The vehicle component may comprise a tire, brake component, hose, gasket, and other like rubber vehicle components. The vehicle may be a vehicle comprising tires.

The vehicle component may comprise a tire. The tire may be vulcanized prior to application of the coating dispersion thereto. The tire may be a “green” tire which has not been vulcanized prior to application of the coating dispersion thereto.

The coating dispersion may be applied to and the rubber coating layer may be formed over any surface of the rubber tire. The rubber coating layer may be formed over an exterior surface of the rubber tire, such as the rim protector, the sidewall, the shoulder, and/or the tread of the tire. The rubber coating layer may be formed over an interior surface of the rubber tire, such as the inner liner of the tire.

The tire over which the rubber coating layer is formed may be an unused rubber tire. The unused rubber tire may be a tire which has been manufactured but not yet mounted to a vehicle for use. The rubber coating layer over the unused rubber tire may preserve the unused tire from oxidative aging and/or UV or ozone degradation until the unused tire is used on a vehicle.

The rubber tire (or other rubber article) having the rubber coating layer formed thereover may be stored for at least one year prior to its use in its intended application, such as mounted to a vehicle and driven on. The rubber coating layer over the rubber tire stored for such long durations may preserve the tire from oxidative aging and/or UV or ozone degradation during the storage time. During use of the tire (after the storage time), the rubber coating layer may delaminate from the tire exposing the rubber tire itself. The rubber tire may be a spare vehicle tire, and the rubber coating layer may be particularly beneficial for spare vehicle tires or other tires which undergo an extended storage time prior to use.

### EXAMPLES

The following examples are presented to demonstrate the general principles of the invention. The invention should not be considered as limited to the specific examples presented.

### Example 1

### Aqueous Coating Dispersion

Part A: In a 32 oz. container, 195.7 g AQUALAST BL-100 (an aqueous butyl elastomer emulsion made by Lord Corporation (Cary, NC)) was measured, and this dispersion was stirred slowly. In a 16 oz. container, 7.2 g BYK-348 (polyether-modified siloxane surfactant available from BYK USA Inc. (Wallingford, CT)), 45.68 g 1 M NH₄OH, and 85.80 g distilled water were combined to form a solution. The solution in the 16 oz. beaker was slowly added into the AQUALAST BL-100 butyl latex dispersion while stirring slowly. Stirring was continued for 15 minutes, and then 6.26 g of an aqueous dispersed zinc oxide (available as Product Code 19205 from Vanderbilt Chemical (Norwalk, CT)), 4.7 g BOSTEX 378 (a 50% active aqueous dispersion of Rubbermaker’s sulfur available from Akron Dispersions (Akron, OH)), 6.27 g SETSIT 5 (activated dithiocarbamate blend available from Vanderbilt Chemical (Norwalk, CT)), and 8.56 g BOSTEX 497B (a 50% active aqueous dispersion of zinc dibutyldithiocarbamate available from Vanderbilt Chemical (Norwalk, CT)) were added to the mixture. Then, 8.23 g BYK-024 (silicone defoamer available from BYK USA Inc. (Wallingford, CT)) was added to the dispersion, which was stirred for 5 minutes. The resulting mixture was Part A.

Part B: In a 16 oz. beaker, 22.69 g 1 M NH₄OH and 65.52 g distilled water were mixed. In a separate 32 oz. container, 318.4 g of MICROLITE 963 (a vermiculite dispersion available from W. R. Grace & Co. (Cambridge, Massachusetts)) was added. The solution from the 16 oz. container was added into the MICROLITE 963 while stirring. Part B was added slowly into Part A while stirring using a low-shear blade. Then 9.94 g of MONARCH 1300 (a carbon black pigment available from Cabot Corporation (Boston, MA)) was added to the stirred mixture. The mixture was left to stir for at least an additional hour.

### Example 2

### Pre-Vulcanized Aqueous Coating Dispersion

Part A: In a 32 oz. container, 194.2 g AQUALAST® BL-100 butyl latex dispersion was measured, and this dispersion was stirred slowly. In a 16 oz. container, 7.2 g BYK-348 wetting agent, 45.08 g 1 M NH₄OH, and 85.80 g distilled water were combined. The solution in the16 oz. container was slowly added into the AQUALAST BL-100 butyl latex dispersion while stirring slowly. The 32 oz. container was placed into a 70° C. water bath with stirring. Stirring in the 70° C. bath was continued for 15 minutes and then 6.24 g of an aqueous dispersed zinc oxide (available as Product Code 19205 from Vanderbilt Chemical (Norwalk, CT)), 4.53 g BOSTEX 378, 6.24 g SETSIT 5, and 8.03 g BOSTEX 497B were added to the mixture. The dispersion was stirred and heated for 2 hours, after which it is removed from the 70° C. water bath and placed in a 25° C. water bath with stirring until cooled. Then, 7.66 g BYK-024 was added to the cooled dispersion, which was stirred for 5 minutes. The resulting mixture was Part A.

Part B: In a 16 oz. beaker, 22.69 g 1 M NH₄OH and 65.52 g distilled water were mixed. In a separate 32 oz. container, 318.4 g of MICROLITE 963 was added. The solution from the 16 oz. container was added into the MICROLITE 963 while stirring. Part B was added slowly into Part A while stirring using a low-shear blade. Then 9.94 g of MONARCH 1300 was added to the stirred mixture. The mixture was then left to stir for at least an hour.

### Example 3

### Forming and Testing Rubber Coating Layers

Rubber coating layers were prepared by hand spraying barrier coatings onto TEDLAR films (available from DuPont (Wilmington, DE)) followed by drying overnight at ambient temperatures followed by baking in an oven for an hour at the temperature listed in Table 1. After baking, the melt temperature of the rubber coating layers were determine by Dynamic Mechanical Analysis (DMA) using a TA Instruments (New Castle, NJ) Q800 from -100° C. to 250° C. at a temperature ramp of 3° C./minute with a strain of 0.1%, force track of 125%, preload force of 0.01 N, using tensile clamp mode with a clamping force of 20 cNm. The melt temperature is where in the DMA test, while the temperature is increasing, the storage modulus of the film suddenly drops by a factor of ten or more. The melt temperature of each rubber coating layer is reported in Table 1.

TABLE 1

| | | |
|---|---|---|
| | Baking Temperature | Melt Temperature |
| Example 1 | 25° C. | 51° C. |
| Example 1 | 50° C. | 60° C. |
| Example 1 | 75° C. | 60° C. |
| Example 1 | 100° C. | 186° C. |
| Example 1 | 116° C. | 224° C. |
| Example 2 | None | 82° C. |

For the aqueous coating dispersion of Example 1 a jump in melt temperature occurred in the formed rubber coating layer between the bake temperature of 75° C. and 100° C., such that rubber coating layers having melt temperatures exceeding 60° C. were achieved at bake temperatures of at least 100° C. A melt temperature exceeding 60° C. is desired so that the rubber coating layer can withstand temperatures commonly reached by rubber vehicle tires during standard vehicle operation. Rubber coating layers having melt temperatures of 60° C. or less may fail due to the rubber vehicle tire reaching or exceeding the melt temperature during standard vehicle operation.

For the pre-vulcanized aqueous coating dispersion of Example 2, a melt temperature of the formed rubber coating layer exceeding 60° C. was achieved without baking the applied pre-vulcanized aqueous coating dispersion.

Whereas particular embodiments of this invention have been described above for purposes of illustration, it will be evident to those skilled in the art that numerous variations of the details of the present invention may be made without departing from the invention as defined in the appended claims.

1. A rubber coating layer prepared from a sprayable aqueous coating dispersion comprising:
a rubber dispersion comprising a rubber binder dispersed in an aqueous medium;
a sulfur-containing vulcanization agent; and
a platy inorganic material,
wherein either:
i) the coating dispersion or a film formed from the coating dispersion is vulcanized at a temperature of from 100° C. to less than 160° C. for up to 1 hour to form the rubber coating layer having a melt temperature of greater than 60° C.; or
ii) the coating dispersion is pre-vulcanized at a temperature of from 70° C. to less than the boiling point of the aqueous medium, and the rubber coating layer is formed by applying the coating dispersion, after the coating dispersion has been pre-vulcanized, over a surface of an article.

2. The rubber coating layer of claim 1, wherein the platy inorganic material comprises vermiculite.

3. (canceled)

4. The rubber coating layer of claim 1, wherein the rubber coating layer is formed over a surface of a rubber tire.

5. The rubber coating layer of claim 4, wherein the rubber tire was vulcanized prior to application of the coating dispersion.

6-9. (canceled)

10. The rubber coating layer of claim 1, wherein the rubber binder comprises a butyl rubber binder.

11. (canceled)

12. The rubber coating layer of claim 1, wherein the rubber dispersion further comprises a surfactant for rendering the rubber binder water dispersible.

13. (canceled)

14. A coated rubber article, comprising:
a rubber article to which a sprayable aqueous coating dispersion has been applied to form a rubber coating layer, wherein the coating dispersion comprises:
a rubber dispersion comprising a rubber binder dispersed in an aqueous medium;
a sulfur-containing vulcanization agent; and
a platy inorganic material,
wherein either:
i) the coating dispersion is vulcanized after application to the rubber article at a temperature of from 100° C. to less than 160° C. for up to 1 hour to form the rubber coating layer having a melt temperature of greater than 60° C.; or
ii) the coating dispersion is pre-vulcanized at a temperature of from 70° C. to less than the boiling point of the aqueous medium prior to application to the rubber article.

15. The coated rubber article of claim 14, wherein the rubber article comprises a rubber tire.

16. The coated rubber article of claim 15, wherein the rubber tire was vulcanized prior to application of the coating dispersion.

17. The coated rubber article of claim 15, wherein the rubber coating layer is formed over an interior surface and/or an exterior surface of the rubber tire.

18-20. (canceled)

21. The coated rubber article of claim 14, wherein the rubber article comprises a vehicle component.

22. The coated rubber article of claim 14, wherein the platy inorganic material comprises vermiculite.

23-24. (canceled)

25. The coated rubber article of claim 14, wherein the rubber binder comprises a butyl rubber binder.

26. (canceled)

27. The coated rubber article of claim 14, wherein the rubber dispersion further comprises a surfactant for rendering the rubber binder water dispersible.

28-43. (canceled)

44. A sprayable pre-vulcanized coating dispersion prepared from a coating dispersion comprising:
a rubber dispersion comprising a rubber binder dispersed in an aqueous medium;
a sulfur-containing vulcanization agent; and
a platy inorganic material,
wherein the coating dispersion is pre-vulcanized at a temperature of from 70° C. to less than the boiling point of the aqueous medium to form the pre-vulcanized coating dispersion.

45. The sprayable pre-vulcanized coating dispersion of claim 44, wherein the coating dispersion is contained in a container, wherein the coating dispersion is vulcanized in the container and prior to the pre-vulcanized coating dispersion being applied to a surface of an article.

46. The sprayable pre-vulcanized coating dispersion of claim 44, wherein the coating dispersion is pre-vulcanized at a temperature of from 70° C. to less than 100° C.

47. The sprayable pre-vulcanized coating dispersion of claim 44, wherein the platy inorganic material comprises vermiculite.

48-49. (canceled)

50. The sprayable pre-vulcanized coating dispersion of claim 44, wherein the rubber binder comprises a butyl rubber binder.

51. (canceled)

52. The sprayable pre-vulcanized coating dispersion of claim 44, wherein the rubber dispersion further comprises a surfactant for rendering the rubber binder water dispersible.

53-80. (canceled)
